(19) United States
(12) Patent Application Publication
(10) Pub. No.: US 2026/0071930 A1
(43) Pub. Date: Mar. 12, 2026

(54) REINGESTION FLAMMABLE FLUID DRAINAGE GROUND TESTING

(71) Applicant: Gulfstream Aerospace Corporation, Savannah, GA (US)

(72) Inventors: Alexander Constantine, Savannah, GA (US); Mitchell Townsend, Savannah, GA (US); John William McAfee, Savannah, GA (US); Randy Nengel, Savannah, GA (US); John Havenar, Savannah, GA (US)

(73) Assignee: Gulfstream Aerospace Corporation, Savannah, GA (US)

(21) Appl. No.: 19/325,150

(22) Filed: Sep. 10, 2025

Related U.S. Application Data
(60) Provisional application No. 63/693,969, filed on Sep. 12, 2024.

(51) Int. Cl. G01M 3/02

(52) U.S. Cl. CPC G01M 3/02

(57) ABSTRACT

Methods and apparatuses for performing ground-based testing for re-ingestion of flammable fluid are provided. An apparatus includes a test section extending from an input port to an exhaust port and including a bottom wall and opposite first and second sidewalls, wherein the sidewalls are configured for connection to the test article; an enclosure configured for connection to the test section over the test article, wherein an interior space is defined between the enclosure and the test article; and an injection port configured to inject a fluid into the test section upstream of the enclosure, wherein the enclosure captures any fluid re-ingested through the test article.

### TECHNICAL FIELD

The technical field relates generally to flammable fluid drainage testing, and more particularly relates to methods and apparatuses for performing ground-based testing for re-ingestion of flammable fluid.

### BACKGROUND

Various authorities throughout the world have the responsibility for establishing and enforcing regulatory requirements for civil aviation. Such regulatory requirements include safety regulations on transport category airplanes that are quite extensive. Implementation and enforcement processes for civil aviation are considerably more intricate and involved than those imposed by other regulatory agencies on land-based and water-based transport vehicles.

Among the required tests for transport category airplanes are flammability tests. These tests apply to various components regarding their usage and sometimes the materials of which the components are made.

For example, a flammable fluid drainage test requires that cells or zones of an aircraft are sufficiently sealed from adjacent zones such that fluid, such as flammable fluid cannot flow between zones. In other words, testing ensures that a flammable fluid is contained within a single zone in case of fire.

Testing may further require that flammable fluid drained at an upstream location not be re-ingested at a downstream location. Reingestion may be a particular concern at mechanical interfaces where gaps may be formed.

Therefore, certain testing requires establishing flight conditions around a test article while determining whether the test article is fluid tight, i.e., no fluid flows through the test article.

Such testing is typically performed during test flights, which can be prohibitively expensive.

Accordingly, it is desirable to provide flammable fluid drainage testing apparatuses and methods that address one or more of the foregoing issues. Furthermore, other desirable features and characteristics of the various embodiments described herein will become apparent from the subsequent detailed description and the appended claims, taken in conjunction with the accompanying drawings and this background.

### SUMMARY

Methods and apparatuses for performing ground-based testing for re-ingestion of flammable fluid are provided.

In a first non-limiting embodiment, an apparatus for performing ground testing of a test article for re-ingestion of flammable fluid includes a test section extending from an input port to an exhaust port and including a bottom wall and opposite first and second sidewalls, wherein the sidewalls are configured for connection to the test article; an enclosure configured for connection to the test section over the test article, wherein an interior space is defined between the enclosure and the test article; and an injection port configured to inject a fluid into the test section upstream of the enclosure, wherein the enclosure captures any fluid re-ingested through the test article.

In certain embodiments, the apparatus further includes a pressure application device to establish a desired pressure within the enclosure.

In certain embodiments, the apparatus further includes a wind tunnel connected to the input port of the test section.

In certain embodiments, the apparatus further includes an air speed sensor for determining an air speed of air flowing through the wind tunnel.

In certain embodiments, the apparatus further includes pressure sensors for determining pressures at selected locations of the apparatus.

In certain embodiments of the apparatus, the bottom wall, first sidewall, second sidewall, and enclosure are transparent, and the apparatus further includes cameras for recording a testing procedure.

In certain embodiments, the apparatus further includes a plurality of steps configured for placement between the test article and the first sidewall and/or second sidewall to adjust for a height differential between a first segment of the test article and a second segment of the test article.

In certain embodiments of the apparatus, the first segment of the test article represents a first aircraft panel, the second segment of the test article represents a second aircraft panel, and an interface between the first segment and the second segment is located in contact with the enclosure to test for re-ingestion of fluid through the interface.

In certain embodiments of the apparatus, the bottom wall is selected from a plurality of bottom walls of different dimensions, and the first sidewall and second sidewalls are selected from a plurality of sidewalls of different dimensions such that the test section is adjustable in size to facilitate connection with test articles of different dimensions.

In another non-limiting embodiment, a method for performing a flammable fluid re-ingestion test includes providing a test article included of a first segment, a second segment, and an interface between the first segment and the second segment, wherein the first segment has a first dimension, and wherein the second segment has a second dimension; selecting a bottom wall, first sidewall, and second sidewall to fit with the test article; assembling a test section from the bottom wall, the first sidewall, and the second sidewall; engaging the first segment of the test article to an upstream portion of the test section, and optionally fitting a first shim or first shims between the first segment and the upstream portion of the test section; engaging the second segment of the test article to a downstream portion of the test section, and optionally fitting a second shim or second shims between the second segment and the downstream portion of the test section; enclosing the interface of the test article with an enclosure to define an interior space between the enclosure and the test article; flowing an air stream through the test section; injecting a fluid into the air stream in the upstream portion of the test section such that the fluid flows past the test article; and monitoring the interior space of the enclosure to determine whether fluid passes through the interface.

In certain embodiments, the method further includes changing a pressure in the interior space of the enclosure to create a pressure differential across the test article.

In certain embodiments, the method further includes monitoring the pressure with a sensor.

In certain embodiments, the method further includes controlling an air speed of the air stream, a flow rate of the fluid, and the pressure to simulate flight conditions.

In certain embodiments, the method further includes recording video of the interior space of the enclosure.

In certain embodiments, the method further includes connecting a wind tunnel to the upstream portion of the test section, wherein the air stream flows from the wind tunnel through the test section.

In certain embodiments, the method further includes sensing an air speed of the air stream.

In certain embodiments of the method, injecting the fluid into the air stream in the upstream portion of the test section includes injecting the fluid in at least two locations.

In another non-limiting embodiment, a method for performing a flammable fluid re-ingestion test includes locating an enclosure defining an interior space over a first side of a test article including an interface; flowing an air stream across an opposite second side of the test article; injecting a fluid into the air stream such that the fluid flows past the test article; and monitoring the interior space of the enclosure to determine whether fluid passes through the interface.

In certain embodiments, the method further includes changing a pressure in the interior space of the enclosure to create a pressure differential across the test article.

In certain embodiments, the method further includes recording video of the interior space of the enclosure.

### BRIEF DESCRIPTION OF THE DRAWINGS

The various embodiments will hereinafter be described in conjunction with the following drawing figures, wherein like numerals denote like elements, and wherein:

FIG. 1 is an exploded perspective view illustrating a flammable fluid drainage ground testing apparatus in accordance with an exemplary embodiment;

FIG. 2 is a non-exploded perspective view of the testing apparatus of FIG. 1 in accordance with an exemplary embodiment;

FIG. 3 is a non-exploded perspective view of the testing apparatus 100 of FIGS. 1 and 2, after the spine is rotated about the rotation axis in accordance with an exemplary embodiment;

FIG. 4 is a schematic view of a testing apparatus in accordance with an exemplary embodiment;

FIG. 5 is a schematic view of an embodiment of a testing apparatus for use with a curved test article in accordance with an exemplary embodiment;

FIG. 6 is a perspective view illustrating a flammable fluid drainage ground testing apparatus for testing for re-ingestion of flammable fluid in accordance with an exemplary embodiment;

FIG. 7 is an exploded perspective view of the testing apparatus of FIG. 6, in accordance with an exemplary embodiment;

FIG. 8 is an overhead view of the testing apparatus of FIG. 6, in accordance with an exemplary embodiment;

FIG. 9 is an overhead view of the testing apparatus of FIG. 6, with the enclosure removed, in accordance with an exemplary embodiment;

FIG. 10 is a side view of the testing apparatus of FIG. 6, in accordance with an exemplary embodiment;

FIG. 11 is a schematic view of a pressurization/depressurization system for use with the testing apparatus of FIG. 6, in accordance with an exemplary embodiment.

### DETAILED DESCRIPTION

The following Detailed Description is merely exemplary in nature and is not intended to limit the various embodiments or the application and uses thereof. Furthermore, there is no intention to be bound by any theory presented in the preceding background or the following detailed description.

The exemplary embodiments taught herein are for use with panels or other components of vehicles, for example, an aircraft or the like.

Exemplary embodiments provide a flammable fluid drainage (FFD) ground testing apparatus and method. By performing the flammable fluid drainage testing on the ground, rather than during test flights, costs are reduced and allow for rapid response design changes to drive to an on aircraft configuration. For example, testing may be substantially completed on the ground such that any fluids leaks that are located may be fixed through the additional of sealant or through design changes. Then a single test flight may be performed to confirm that the ground test detected all leaks.

An exemplary apparatus receives coupons that mimic areas of flammable fluid drainage concern. Further, the exemplary apparatus allows for fluid to be sprayed on one side of the coupon while vacuum pressure is applied on the other. The exemplary apparatus also allows for vibration application. Also, coupon orientation relative to the vibration plane and level may be selected and obtained. Pressures and fluid flow rates may be controlled and all data may be monitored and recorded. The exemplary apparatus allows for viewing on both sides of the coupon during testing.

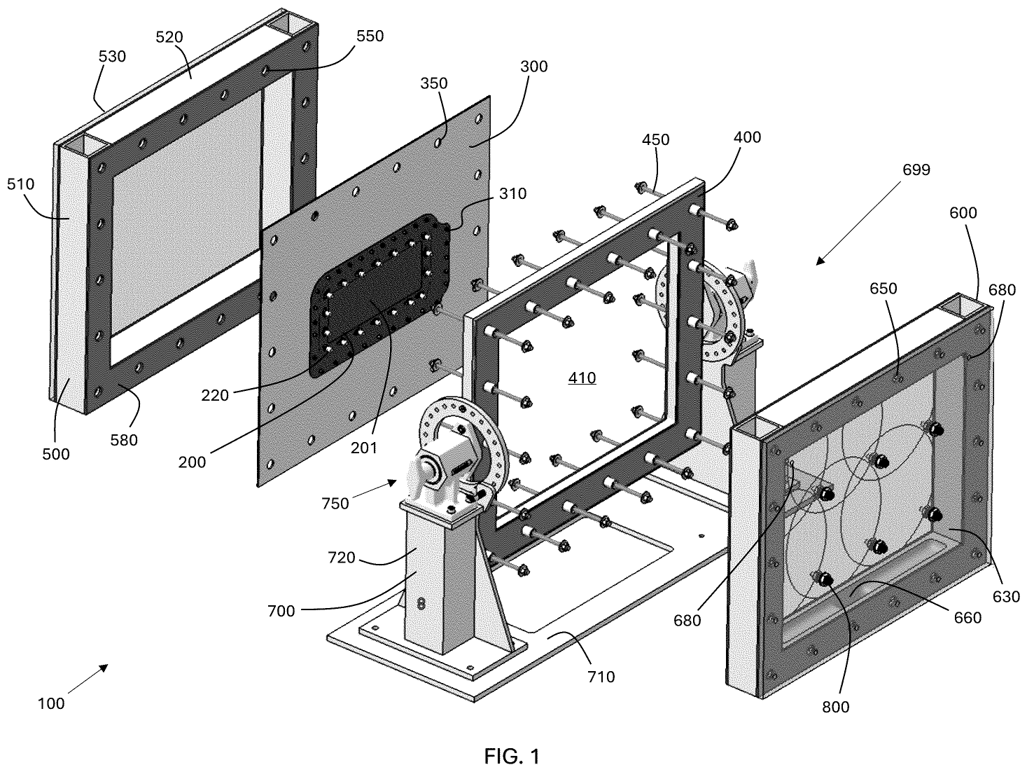

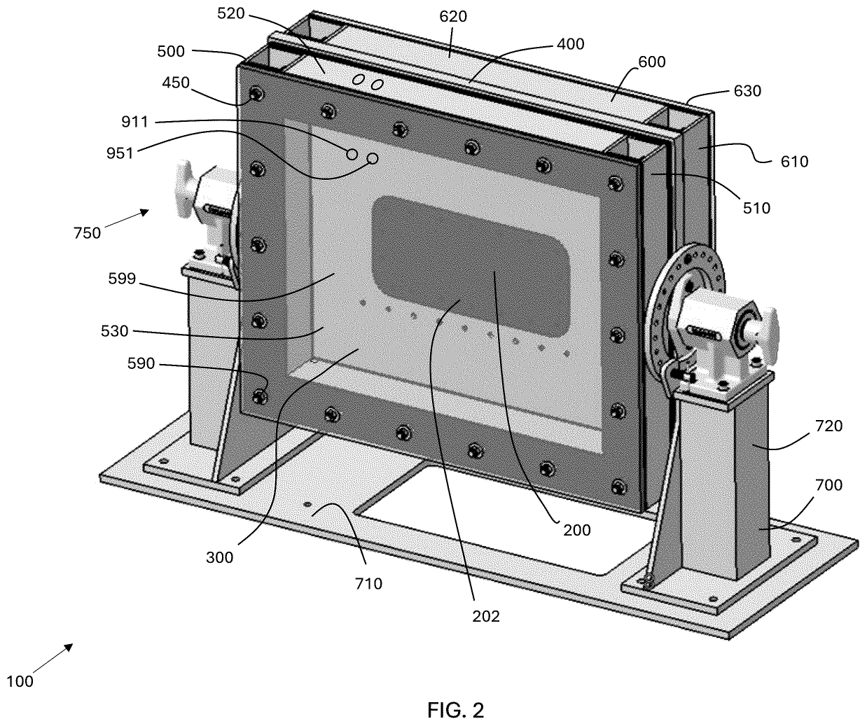

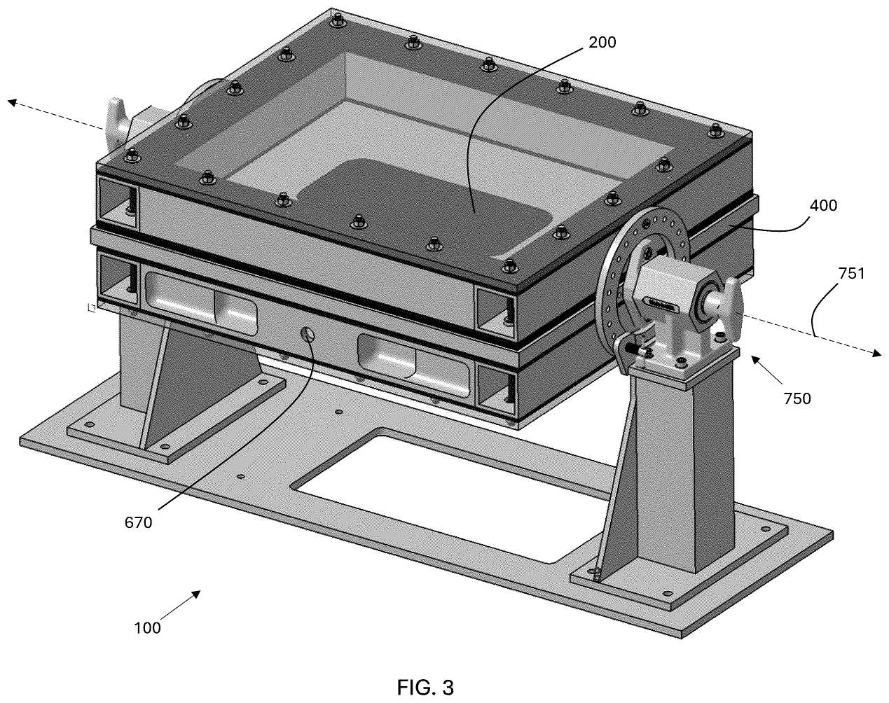

FIG. 1 is an exploded perspective view of a testing apparatus 100. FIG. 2 is a non-exploded perspective view of the testing apparatus 100 of FIG. 1. FIG. 3 is a non-exploded perspective view of the testing apparatus 100 of FIGS. 1 and 2, after the spine is rotated about the rotation axis.

Cross-referencing FIGS. 1-3, the testing apparatus 100 is configured to receive a test article 200. The test article 200 may be a “full stack up” element including a plurality of components that are interconnected. For example, the test article 200 may include all components as arranged in a region of an aircraft. The test article may be substantially planar and relatively thin, or may include features that extend outward from the plane of the test article.

As shown, the test article 200 is received in a coupon 300. For example, the coupon 300 may be formed with an opening 310 that is dimensioned to receive the test article 200. The test article 200 may overlap with the coupon 300 around the opening 310 and may be fixed to the coupon 300 with fasteners 220. With this arrangement neither a first side 201 nor a second side 202 of the test article 200 is covered by the coupon 300. Further, the test article 200 may be mounted to subplates to fit into any of the standard apparatus sizes.

As further shown in FIGS. 1-3, the coupon 300 may be received on and fixed to a spine 400. As shown, the spine 400 is also formed with a central opening 410. The first side 201 of the test article 200 is fitted within the central opening 410. To connect the coupon 300 and spine 400, the spine 400 includes projections 450, such as bolts, that are received within and pass through bores or holes 350 in the coupon 300. A gasket may be located between the coupon 300 and the spine 400.

Further, two wall structures 500 and 600 are provided to encase the test article 200 within the apparatus 100.

For example, wall structure 500 connects to the coupon 300, and may compress the coupon 300 between the spine 400 and the wall structure 500. As shown, the wall structure 500 includes vertical beams 510 that are interconnected by lateral beams 520. Further, an outer transparent window 530 is sealed to the beams 510 and 520. A gasket 580 may be located between the wall structure 500 and the coupon 300. As shown, the gasket 580 and wall structure 500 include bores or holes 550 to receive the projections 450 for connection to the spine 400. Fasteners 590, such as nuts, may be tightened to enclose a fluid-tight chamber 599 between the window 530 and the coupon 300 and test article 200 therein.

As shown, window 530 may be formed with a pressure data port 911 and a pressure application port 951. Alternatively, ports 911 and 951 may be formed in the lateral beam 520 as indicated or in other structure bounding chamber 599.

Further, wall structure 600 connects to the spine 400. As shown, the wall structure 600 includes vertical beams 610 that are interconnected by lateral beams 620. Further, an outer transparent window 630 is sealed to the beams 610 and 620. A gasket may be located between the wall structure 600 and the spine 400. As shown, the wall structure 600 include bores or holes 650 to receive the projections 450 for connection to the spine 400. Fasteners, such as nuts, may be tightened to enclose a chamber 699 between the window 630 and the coupon 300 and test article 200 therein. Window 630 may be formed with vents 680 to ensure ambient pressure in chamber 699.

Nozzle devices 800 are provided in a desired arrangement on and through window 630 and are configured to spray fluid onto the test article 200 within the chamber 699. Also, the lower lateral beam 620 of wall structure 600 may be formed with a pocket 660 that leads to a drain 670 for removing fluid from the chamber 699.

As further shown, the spine 400 and/or wall structures 500 and 600 are supported by a frame 700. The frame 700 includes a base 710 and legs 720 that extend upwardly from the base 710. As shown, a rotary mount 750 is located at the upper end of each leg 720 and connects to the spine 400 and/or wall structures 500 and 600. As a result, the spine 400 and/or wall structures 500 and 600, and the test article 200 when mounted therein, may be positioned at any plane passing through the rotation axis 751 of the rotary mount 750. The rotary mount 750 may include a motor to rotate according to a program or upon demand from a controller or from a user. Further, the rotary mount 750 may lock at any desired angle to hold the connection without further rotation.

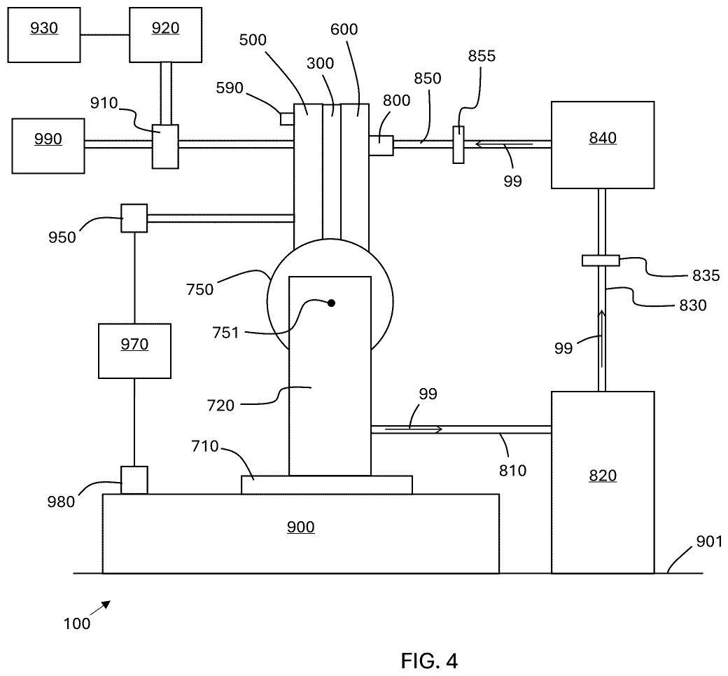

FIG. 4 further provides a schematic layout of the apparatus 100. As shown, in FIG. 4, the base 710 of the frame 700 is mounted on and to a shaker device 900, such as a shaker table or platform. The shaker device 900 may be mounted on or include wheels to provide for easy transport of the apparatus 100. As shown, the shaker device 900 rests on the ground surface 901. The shaker device 900 is configured to apply an excitation input to the test article 200. The shaker device 900 may shake and/or vibrate, producing the excitation input that is communicated to the test article 200.

In the apparatus 100 of FIG. 4, a tube 810 or hose is provided and removes fluid 99 from the drain 670 in the wall structure 600. The tube 810 carries fluid 99 to a recirculation tank 820. Further, a flow controller 840 removes fluid 99 from the recirculation tank 820 through a tube 830 or hose. A pump 835 may be provided to pump fluid 99 through tube 830. Also, the flow controller 840 directs the fluid 99 through tube 850 or hose to nozzle devices 800. The nozzle devices 800 are configured to spray the fluid 99 onto the test article 200 held within chamber 699. A flow meter 855 may be provided on tube 850 to monitor the flow rate of the fluid 99.

As further shown in FIG. 4, a pressure device 990 is provided in fluid communication with the chamber 599. The pressure device 990 may be a vacuum device configured to reduce the pressure within the chamber 599. As a result, a pressure differential may be applied across the test article 200.

As shown in FIG. 4, a vacuum booster or regulator 910 may be connected between the pressure device 990 and the chamber 599, specifically through port 911 shown in FIG. 2. As further shown in FIG. 4, a voltage to pressure transducer or E/P transducer 920 may be operatively connected to the regulator 910. Also, a potentiometer 930 may be operatively connected to the E/P transducer 920.

As arranged, the potentiometer 930 may be used to control the vacuum pressure applied from pressure device 990 to the chamber 599. Specifically, the potentiometer 930 may adjust a voltage or signal input to the E/P transducer 920, thereby varying the output pressure from the E/P transducer 920 to the regulator 910 and the regulated pressure applied to the chamber 599.

As further illustrated in FIG. 4, the apparatus 100 may include a pressure sensor, such as a pressure transducer 950, in communication with the chamber 599, specifically through port 951 shown in FIG. 2. In FIG. 4, pressure transducer 950 may be provided to convert the chamber pressure to an electric pressure signal. As shown, the pressure transducer 950 is electrically connected to a data acquisition system 970, and may communicate the electric pressure signal to the data acquisition system 970. Further, a transducer 980 may be located on the frame 700, such as on the base 710 of the frame 700. Transducer 980 may be an accelerometer configured to generate an electrical signal output from a mechanical acceleration input, e.g., the excitation input from the shaker device 900. As shown the transducer 980 is electrically connected to the data acquisition system 970, and may communicate the electric signal output to the data acquisition system 970. As arranged, the data acquisition system 970 may monitor the pressure in the chamber 599 and the mechanical excitation input to the chamber 599.

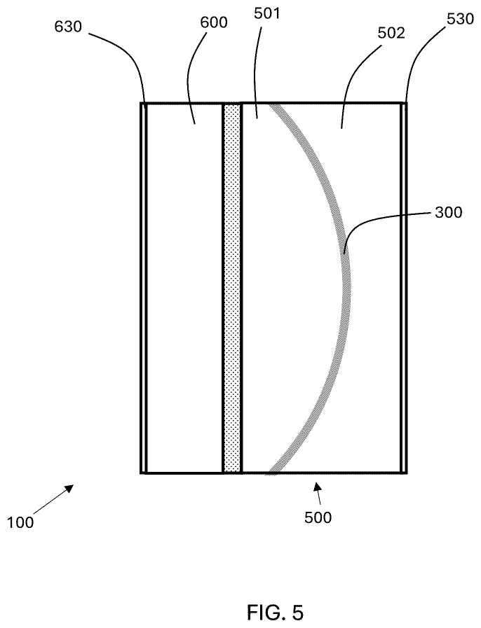

In FIG. 5, the apparatus 100 is provided with structures for adaptation for use with curved test articles. As shown, in FIG. 5, the coupon 300 is curved, such that the coupon 300 has a same curvature as the test article. As shown, the wall structure 500 is provided with a first spacer 501 having an outer surface matching the curvature of the coupon 300. The first spacer 501 is located between the spine 400 and the coupon 300. Further, the wall structure 500 is provided with a second spacer 502 having an inner surface matching the curvature of the coupon 300. The second spacer 502 is located between the coupon 300 and the window 530. Thus, the wall structure 500 may enclose a chamber 599 around a curved test article.

Cross-referencing FIGS. 1-5, it may be seen that the apparatus 100 may be designed to perform a test on a test article of any desired dimensions and shape. Further, the apparatus 100 may be operated to apply a desired flow amount of fluid onto the test article 200 for a desired duration and according to a pattern that may vary; to apply a desired pressure differential or pressure differentials across the test article 200; to apply a desired acceleration from the shaker device to the test article 200; and to position the test article 200 at a desired plane or planes of rotation during the testing.

In an exemplary embodiment, a method includes forming the coupon 300 as the test article 200 or with the test article 200. The coupon 300 may be formed with a universal perimeter for connection to the spine 400.

Based on the test article, a depth for testing the test article is determined. In the method, the chambers 599 and/or 699 are prepared by assembling the wall structures 500 and 600 with sufficient depth to hold the test article.

Thus, after assembling the appropriate apparatus 100 from a coupon 300, wall structure 500, and wall structure 600 of desired dimension appropriate for use with the test article, the apparatus 100 is mounted to the rotary mount 750 resting on the frame 700 located on the shaker device 900. Further, the flow controller 840 and pressure device 990 are connected to the respective chambers 699 and 599.

Then a testing procedure may be selected. For example, a start time, flow rate, and flow duration for spraying fluid onto the test article 200 may be selected. Various pressure differentials may be applied during testing. For example, a first differential pressure may be applied at a desired start time and for a desired duration, and a second differential pressure may be applied at a desired start time and for a desired duration. Any suitable levels of differential pressure may be used. Also, the shaker device 900 may apply a desired excitation input beginning at a desired start time for a desired duration. Further, the rotary device 750 may rotate the test article 200 to a desired plane, and then to a second desired plane, and to any number of successive desired planes, at scheduled times during the test process.

The method includes video recording, or viewing, the chamber 599 and the test article 200 therein through window 530 to determine where a fluid leak occurs in the test article. Because the testing procedure occurs on the ground, the test article may be immediately revised, such as by the addition of sealant in selected areas, or even a re-design of components. Iterations of the testing and revisions may be continued to be performed until the test article passes the testing procedure by not leaking. Then, a test flight may be performed to confirm that all test articles do not leak under flight conditions.

As described herein, the testing apparatus may be used to mimic any condition that the test article may undergo during a flight. Thus, the testing apparatus provides for inexpensively re-creating flight conditions to allow for flammable fluid drainage testing of a test article.

Further exemplary embodiments provide for ground-based testing for re-ingestion of flammable fluids. By performing testing for re-ingestion on the ground, rather than during test flights, costs are reduced and allow for rapid response design changes to drive to an on aircraft configuration. For example, testing may be substantially completed on the ground such that any fluids leaks that are located may be fixed through the additional of sealant or through design changes. Then a single test flight may be performed to confirm that the ground test detected all leaks.

An exemplary apparatus receives coupons that mimic areas of re-ingestion concern. Further, the exemplary apparatus allows for fluid to be sprayed into an air stream upstream of the coupon to simulate conditions for re-ingestion during a flight. Pressures and fluid flow rates may be controlled and all data may be monitored and recorded. The exemplary apparatus allows for viewing on both sides of the coupon during testing.

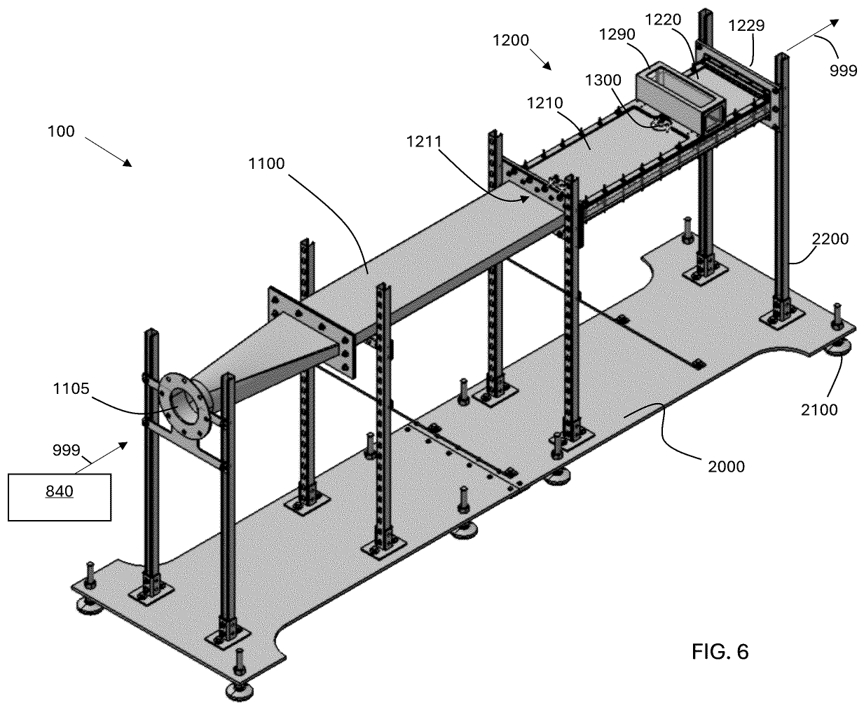

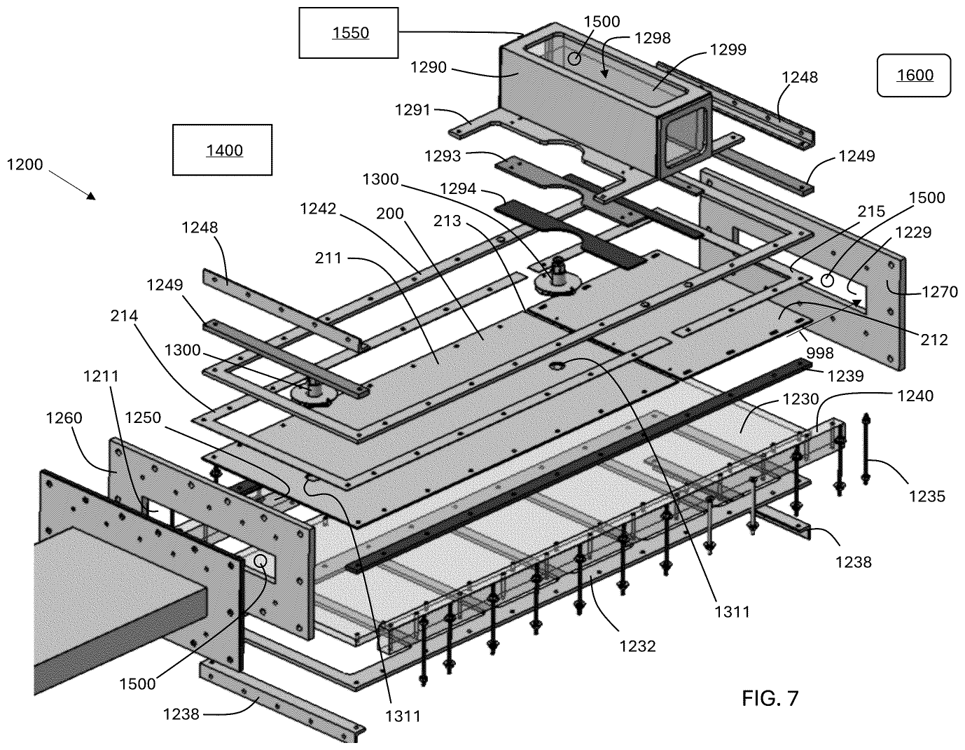

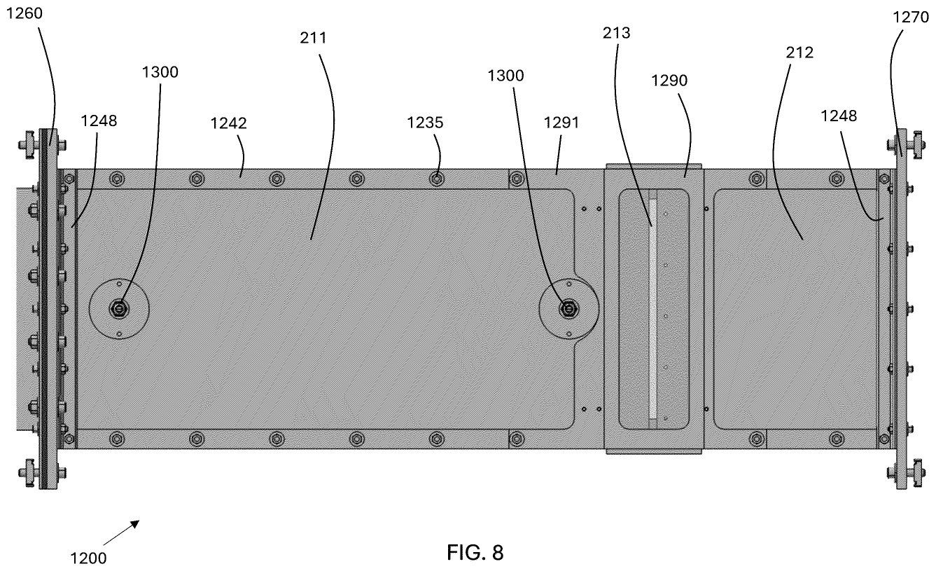

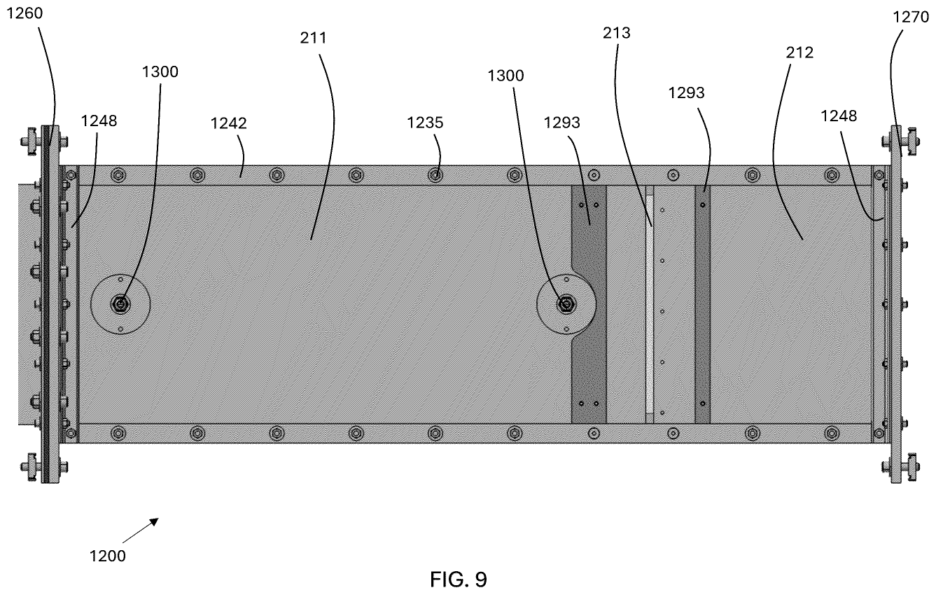

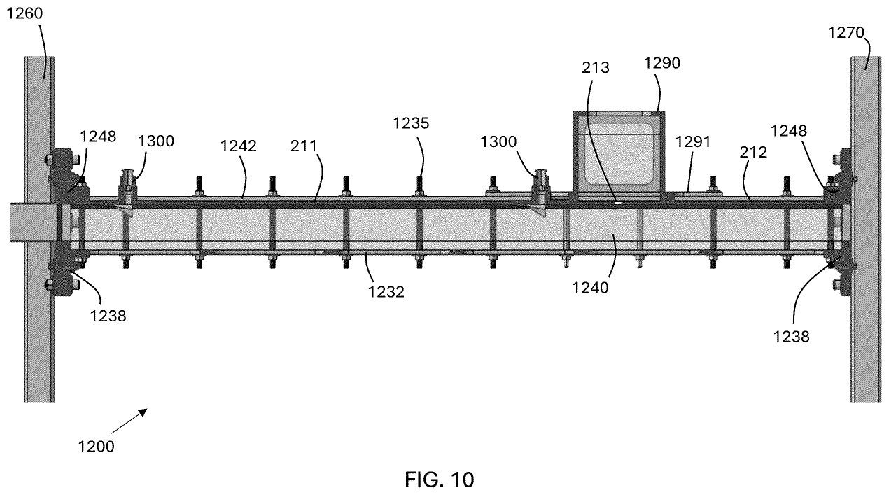

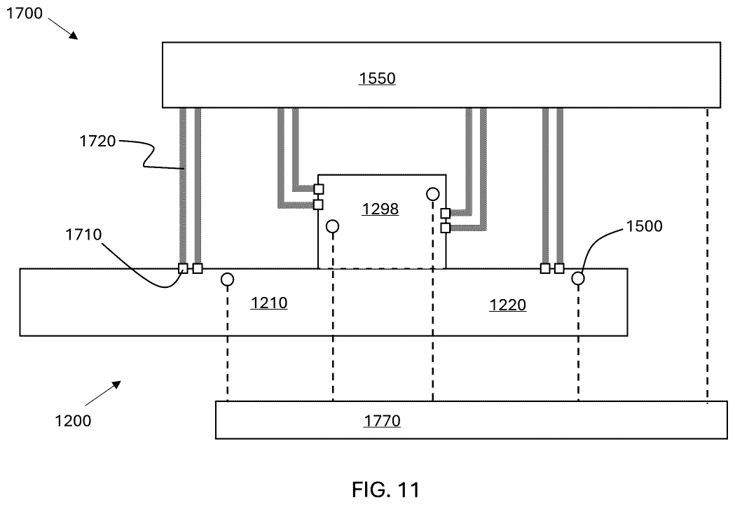

FIGS. 6-11 illustrates various features of an apparatus 100 for performing ground-based testing for re-ingestion of flammable fluids. FIG. 6 is a perspective view illustrating the ground-based testing apparatus 100, FIG. 7 is an exploded perspective view of the testing section 1200 of the testing apparatus 100; FIG. 8 is an overhead view of the testing section 1200; FIG. 9 is an overhead view of the testing section 1200, with the enclosure removed for purposes of description; FIG. 10 is a side view of the testing section 1200, and FIG. 11 is a schematic illustrating pressurization/depressurization system provided for the testing section 1200.

In FIG. 6, the testing apparatus 100 includes a testing section 1200 having an upstream portion 1210, a downstream portion 1220, and an enclosure 1290. The testing section 1200 extends from an input port 1211 formed in the upstream portion 1210 to an outlet port 1229 formed in the downstream portion 1220. Further, the testing apparatus 100 may include a wind tunnel 1100 connected to the input port 1211 of the upstream portion 1210 of the testing section 1200. As shown, the wind tunnel 1100 includes an input port 1105. An air stream identified by arrow 999 flows through the testing apparatus 100, from the input port 1105, through the testing section input portion 1211 and through testing section 1200, and out of exit port 1229.

As shown the testing apparatus 100 includes a base 2000 that is supported at a selected height from the ground by adjustable feet 2100. Further, the testing apparatus 100 includes legs 2200 that support the wind tunnel 1100 and testing section 1200 at a desired height. The wind tunnel 1100 and testing section 1200 may be connected directly to the legs 2200, may be supported by cross beams connected to the legs 2200, or may be structurally supported in another manner.

FIGS. 7-10 may illustrate the components of the testing section 1200 more clearly. As shown, the testing section 1200 is formed by a bottom wall 1230, a first sidewall 1240, and an opposite second sidewall 1250 (largely hidden). In certain embodiments, the bottom wall 1230, first sidewall 1240, and second sidewall 1250 are transparent. For example, the bottom wall 1230, first sidewall 1240, and second sidewall 1250 made be made from a transparent acrylic material. Further, testing section 1200 may include an upstream end wall 1260 and a downstream end wall 1270 as shown. End wall 1260 may be formed with and define the inlet port 1211, and end wall 1270 may be formed with and define the outlet port 1229.

As shown, bottom wall 1230 may be received within or on a bottom frame 1232 and interconnected to the sidewalls 1240 and 1250 via fasteners 1235. Also, bottom braces 1238 may provide for interconnection between the bottom wall 1230 and the end walls 1260 and 1270, such as via fasteners.

The upper boundary of the testing section 1200 may be formed by the testing article 200 itself. The testing section 1200 is received within or under an annular upper frame 1242. As a result, a fluid pathway, indicated by arrow 998, is defined through the testing section 1200.

As shown, the testing article 200 is formed from a first article section 211 and a second article section 212. In certain embodiments, the first article section 211 is, or represents, a first aircraft component or panel and the second article section 212 is, or represents, a second aircraft component. The components, and sections 211 and 212, are joined at an interface 213. Herein, re-ingestion testing may be focused on the interface 213. Specifically, testing is performed to determine whether flammable fluid may flow through the interface 213, such as under conditions that may be experienced during flight. The interface 213 may comprise a sealant, adhesive, a mechanical fastener or structure, or other element for connecting the first article section 211 and second article section 212.

It is noted that the first article section 211 and second article section 212 may have different dimensions, such different thicknesses or heights. In order to accommodate different thicknesses while providing a sealed connection to the upper frame 1242, the testing section 1200 includes a first shim 214 and a second shim 215. The shims 214 and 215 are selected, such as from a plurality of shims of different thicknesses, to provide a planar upper surface for connection to the upper frame 1242 even if a step in height exists between the two sections 211 and 212. Also, upper braces 1248 may provide for interconnection between the upper frame 1242, and testing article 200, and the end walls 1260 and 1270, such as via fasteners. As shown, sealing members 1249 may be located between the upper braces 1248 and the upper frame 1242.

As shown, enclosure 1290 may be fixed to a support member 1291. Further, braces 1293 and sealing members 1294 may be located between the support member 1291 and the upper frame 1242 and testing article 200. It is noted that the bottom of the enclosure 1290 is open. As a result, the interface 213 separates the fluid pathway 998 from the interior space enclosed between the enclosure 1290 and the testing article 200. As shown, the interior space 1298 is visible through transparent windows 1299 that form the enclosure 1290. Fluid that passes through the interface 213 is captured in the enclosure 1290.

As shown, the first article segment 211 is formed with two openings 1311. Further, two nozzles or injection ports 1300 are provided and fit in openings 1311. The injection ports 1300 are configured to inject or spray a testing fluid into the fluid pathway 998 through the testing article 200. The injection ports 1300 may be in fluid communication with a fluid source 1400. In certain embodiments, a single opening 1311 and a single injection port 1300 are provided. In other embodiments, more than two openings 1311 and more than two injection ports 1300 are provided.

As shown, sensors 1500 may be provided at selected locations, including pressure sensors, temperature sensors, and flow rate sensors. While sensors 1500 may be located in any desired location, in FIG. 7 a sensor 1500 is located within the interior space 1298 of the enclosure 1290, at the inlet port 1211 and at the outlet port 1229.

As further shown, a camera or cameras 1600 may be located to record video or still images, such as of the interior space 1298 of the enclosure 1290. As a result, a record of a testing procedure results may be saved. The camera 1600 may be configured to provide high speed video recording and/or regular speed video recording.

In certain embodiments, the air speed of the air stream through the apparatus 100 may be controlled to a speed of from zero to 500 feet per second. Air flow sensors 1500 may monitor the air speed at any desired location, such as at all inlets. Data from the air flow sensors 1500 may be communicated to a controller 840 that may modify the air speed as desired. In certain embodiments, the air is delivered to the apparatus 100 from a pressurized tank. In certain embodiments, a pressure differential between the air flow in the test section 1200 and the interior space 1298 of the enclosure 1290 may be monitored by sensors 1500 and communicated to the controller 840. In certain embodiments, a pressure application device 1550 may be located at the enclosure to establish a desired pressure within the enclosure. For example, the pressure application device 1550 may be a vacuum. Thus, the pressure differential may be established as a result of the input air speed and the input of the pressure application device 1550.

Embodiments herein provide for selecting both the height difference, or step, between article segments 211 and 212, and for selecting the distance from article segment 211 to article segment 212, i.e., the width of the interface 213.

FIG. 11 is a block diagram illustrating that the testing section 1200 of the testing apparatus 100 is provided with a pressurization/depressurization system 1700. As shown, the system 1700 may include orifices 1710 that are provided for selectively controlling or adjusting the pressure within the testing section 1200, and within the interior space 1298 enclosed by enclosure 1290 specifically. As shown, orifices 1710 are formed in the enclosure 1290. Optionally, orifices 1710 also may be formed in the structure of the upstream portion 1210 and/or downstream portion 1220 of testing section 1200 as shown, i.e., in the bottom wall 1230, sidewall 1240, sidewall 1250 (identified in previous Figures).

As shown, a pressure application device 1550 may be provided to establish a desired pressure within the enclosure 1290, and optionally within the upstream portion 1210 and/or downstream portion 1220 of testing section 1200. Various pressure differentials may be established as a result of the input air speed and the selected inputs of the pressure application device 1550. The pressure application device 1550 is provided in fluid communication with the orifices through tubing 1720. The pressure application device 1550 may be a vacuum device configured to reduce the pressure at the location of selected orifices 1710 or a pressure generator configured to increase the pressure at the location of selected orifices 1710.

As further illustrated in FIG. 10, the apparatus 100 may include pressure sensors 1500 located in the enclosure 1290, in the upstream portion 1210 and in the downstream portion 1220 of testing section 1200. As shown, each pressure sensor 1500 is electrically connected to a data acquisition system 1770, and may communicate the electric pressure signal to the data acquisition system 1770. As shown, the data acquisition system 1770 may be electrically connected to the pressure application device 1550.

With the structure described in FIG. 11, the system 1700 and method may be used to closely model actual pressure conditions that an aircraft in flight would experience. For example, during a testing procedure, a sensor 1500 within the interior space 1298 of the enclosure 1290 may indicate that the pressure at that location is too low or too high as compared to the pressure expected at that location when the aircraft is in flight. Thus, the system 1700 may selectively increase or reduce pressure at that location via the orifice or orifices 1710 at that location or at the location and other locations.

In an exemplary embodiment, a method for testing includes simulating flammable fluid drainage and flow. For example, the method may include installing the test article 200 in the testing apparatus 100. As described above, the various structures of the testing section 1200 may be selected to work with the specific dimensions of the sections 211 and 212, and interface 213, of the test article 200.

The method may further include performing a pre-test check to ensure that the instrumentation and recording equipment are installed and are operational.

Then, the method may include ramping the velocity of air flow through the apparatus 100 to a selected air speed, such as 100 ft/s, and ensuring that the air flow stabilizes at the selected air speed.

The method may include regulating the pressure differential to a specified value.

The method may further include beginning video recording on the high-speed camera and introducing dyed fluid, such as dyed water, from the fluid source to the injection ports and injecting the dyed fluid into the air flow.

Recording and fluid injection may continue for a selected period of time, such as sixty seconds. Then, dyed fluid flow is stopped.

The method may then include stopping the air flow through the apparatus 100, i.e., returning the air flow to zero, and allowing the air tanks to re-pressurize.

The method may then include photographing the backside of the testing article and other desired locations to provide a still record of the testing results. Further, the data from the testing process, including pressures, air speeds, fluid flow rates, times, etc., may be exported along with video clips from the high speed camera.

The windows in the enclosure, bottom wall, and sidewalls may then be cleaned as needed. Further, re-pressurization of the air tanks may be verified before a second testing process is performed.

The testing procedure may then be repeated at air flow speeds of 200 ft/s, 300 ft/s, 400 ft/s, and 500 ft/s, or at any other desired air flow speeds.

After testing is complete, the test article 200 may be removed from the testing apparatus, and another test article may be tested.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It being understood that various changes may be made in the function and arrangement of elements described in an exemplary embodiment without departing from the scope of the disclosure as set forth in the appended claims.

What is claimed is:

1. An apparatus for performing ground testing of a test article for re-ingestion of flammable fluid, the apparatus comprising:
a test section extending from an input port to an exhaust port and including a bottom wall and opposite first and second sidewalls, wherein the sidewalls are configured for connection to the test article;
an enclosure configured for connection to the test section over the test article, wherein an interior space is defined between the enclosure and the test article; and
an injection port configured to inject a fluid into the test section upstream of the enclosure, wherein the enclosure captures any fluid re-ingested through the test article.

2. The apparatus of claim 1, further comprising a pressure application device to establish a desired pressure within the enclosure.

3. The apparatus of claim 2, further comprising a wind tunnel connected to the input port of the test section.

4. The apparatus of claim 3, further comprising an air speed sensor configured to determine an air speed of air flowing through the wind tunnel.

5. The apparatus of claim 4, further comprising pressure sensors configured to determine pressures at selected locations of the apparatus.

6. The apparatus of claim 5, wherein the bottom wall, first sidewall, second sidewall, and enclosure are transparent, and wherein the apparatus further comprises cameras for recording a testing procedure.

7. The apparatus of claim 6, further comprising a plurality of steps configured for placement between the test article and the first sidewall and/or second sidewall to adjust for a height differential between a first segment of the test article and a second segment of the test article.

8. The apparatus of claim 7, wherein the first segment of the test article represents a first aircraft panel, wherein the second segment of the test article represents a second aircraft panel, and wherein an interface between the first segment and the second segment is located in contact with the enclosure to test for re-ingestion of fluid through the interface.

9. The apparatus of claim 8, wherein the bottom wall is selected from a plurality of bottom walls of different dimensions, and wherein the first sidewall and second sidewalls are selected from a plurality of sidewalls of different dimensions such that the test section is adjustable in size to facilitate connection with test articles of different dimensions.

10. A method for performing a flammable fluid re-ingestion test, the method comprising:
providing a test article comprised of a first segment, a second segment, and an interface between the first segment and the second segment, wherein the first segment has a first dimension, and wherein the second segment has a second dimension;
selecting a bottom wall, first sidewall, and second sidewall to fit with the test article;
assembling a test section from the bottom wall, the first sidewall, and the second sidewall;
engaging the first segment of the test article to an upstream portion of the test section, and optionally fitting a first shim or first shims between the first segment and the upstream portion of the test section;
engaging the second segment of the test article to a downstream portion of the test section, and optionally fitting a second shim or second shims between the second segment and the downstream portion of the test section;
enclosing the interface of the test article with an enclosure to define an interior space between the enclosure and the test article;
flowing an air stream through the test section;
injecting a fluid into the air stream in the upstream portion of the test section such that the fluid flows past the test article; and
monitoring the interior space of the enclosure to determine whether fluid passes through the interface.

11. The method of claim 10 further comprising changing a pressure in the interior space of the enclosure to create a pressure differential across the test article.

12. The method of claim 11, further comprising monitoring the pressure with a sensor.

13. The method of claim 12, further comprising controlling an air speed of the air stream, a flow rate of the fluid, and the pressure to simulate flight conditions.

14. The method of claim 13, further comprising recording video of the interior space of the enclosure.

15. The method of claim 14, further comprising connecting a wind tunnel to the upstream portion of the test section, wherein the air stream flows from the wind tunnel through the test section.

16. The method of claim 10, further comprising sensing an air speed of the air stream.

17. The method of claim 10, wherein injecting the fluid into the air stream in the upstream portion of the test section comprises injecting the fluid in at least two locations.

18. A method for performing a flammable fluid re-ingestion test, the method comprising:
locating an enclosure defining an interior space over a first side of a test article including an interface;
flowing an air stream across an opposite second side of the test article;
injecting a fluid into the air stream such that the fluid flows past the test article; and
monitoring the interior space of the enclosure to determine whether fluid passes through the interface.

19. The method of claim 18 further comprising changing a pressure in the interior space of the enclosure to create a pressure differential across the test article.

20. The method of claim 19, further comprising recording video of the interior space of the enclosure.
